(19) United States
(12) Patent Application Publication
(10) Pub. No.: US 2014/0115484 A1
(43) Pub. Date: Apr. 24, 2014

(54) APPARATUS AND METHOD FOR PROVIDING N-SCREEN SERVICE USING DEPTH-BASED VISUAL OBJECT GROUPINGS

(71) Applicant: Electronics and Telecommunications Research Institute, Daejeon-si (KR)

(72) Inventors: Kwang-Yong KIM, Daejeon-si (KR); Chang-Woo YOON, Daejeon-si (KR)

(73) Assignee: Electronics and Telecommunications Research Institute, Daejeon-si (KR)

(21) Appl. No.: 14/057,718

(22) Filed: Oct. 18, 2013

(30) Foreign Application Priority Data
Oct. 19, 2012 (KR) 10-2012-0116919
Sep. 24, 2013 (KR) 10-2013-0113380

(51) Int. Cl. G06F 3/0481

(52) U.S. Cl. CPC G06F 3/04815
USPC 715/738; 715/852

(57) ABSTRACT

An apparatus and method for providing multimedia content service are provided. A method for providing an image service using at least two screens of different types in an N-screen service providing apparatus includes: separating and extracting independent visual objects from an image based on depth values; grouping the extracted independent visual objects into a number of groups and composing scenes with the respective groups of visual objects; and selectively reproducing one or more scenes with the groups of visual objects on at least two screens in response to a user interaction event.

### CROSS-REFERENCE TO RELATED APPLICATION(S)

This application claims priority from Korean Patent Application Nos. 10-2012-0116919, filed on Oct. 19, 2012, and 10-2013-0113380, filed on Sep. 24, 2013, in the Korean Intellectual Property Office, the disclosures of which are incorporated herein by references in their entirety.

### BACKGROUND

1. Field

The following description relates to an apparatus and method for providing multimedia content service, and more particularly, to an apparatus and method for producing visual objects based on depth-based groupings and providing objects of each grouping through an N-screen service.

2. Description of the Related Art

Today, 2D or 3D video or still images, as well as 3D video games and other media, are serviced in real-time streaming or in the form of Video on Demand (VoD) based on a download-and-play technique. Development of application services from media object extraction and object-based coding based on MPEG-4 standards has continued to process various types of images.

As application service techniques based on media object extraction and object-based coding in accordance with MPEG-4 standards, there are MPEG-4-based object generation (Korean Patent Publication No. 2003-0037614, titled MPEG-4 CONTENT GENERATING METHOD AND DEVICE, by Kim, Sang-wook et al.), an image processing technique for extracting an object (Korean Patent Publication No. 2012-0071226, titled “OBJECT EXTRACTION METHOD AND DEVICE, by Ko, Jong-kook et al.) and an image processing method capable of obtaining depth information (Korean Patent Publication No. 2012-0071219, titled “3D depth information acquisition device and method, by Park, Ji-yeong et al.).

In the aforementioned related art, if visual objects, such as background, persons, and vehicles, in a 2D or 3D video or still image are overlapping each other, it is impossible for a viewer to clearly see each of objects included in the 2D or 3D video or still image. Visual objects behind the overlapping objects are not shown to the viewer.

### SUMMARY

The following description relates to an apparatus and method for allowing a user to view scenes on different screens, wherein independent visual (video or still image) objects are grouped based on a grouping value and are produced based on the groupings, and the scenes composed of visual objects of each grouping are extracted as a unit of object of interest that can interact with the user.

In one general aspect, there is provided a method for providing an image service using at least two screens of different types in an N-screen service providing apparatus, the method including: separating and extracting independent visual objects from an image; grouping the extracted independent visual objects into a number of groups based on depth values and composing scenes with the respective groups of visual objects; and selectively reproducing one or more scenes with the groups of visual objects on one or more among at least two screens in response to a user interaction event.

In another general aspect, there is provided an apparatus for providing an N-screen service using a depth-based visual object group, the apparatus including: an independent visual object extracting unit configured to extract independent visual objects from an image; a group-based visual object producing unit configured to group the extracted independent visual objects into a number of groups based on depth values and produce one or more scenes composed of visual objects of each grouping; and an N-screen unit configured to comprise at least two screens to selectively reproduce the one or more produced scenes according to a user interaction event.

Other features and aspects will be apparent from the following detailed description, the drawings, and the claims.

### BRIEF DESCRIPTION OF THE DRAWINGS

FIG. 1 is a diagram illustrating an MPEG-4 system reference model.

FIG. 2 is a configuration diagram illustrating an N-screen service providing apparatus using depth-based visual object groupings according to an exemplary embodiment of the present invention.

FIG. 3 is a diagram illustrating in detail a group-based visual object producing unit according to an exemplary embodiment of the present invention.

FIG. 4 is a diagram illustrating an N-screen unit according to an exemplary embodiment of the present invention.

FIG. 5 to FIG. 7 are flowcharts illustrating a method of providing an N-screen service using a depth-based grouped visual objects according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, there are provided an apparatus and method for allowing a user to view scenes on different screens, wherein independent visual (video or still image) objects are grouped based on a grouping value and are produced based on the groupings, and the scenes composed of visual objects of each grouping are extracted as a unit of object of interest that can interact with the user. MPEG-4, as an international standard, is used for high compression rate through object-based coding with respect to visual objects and for various application services of digital video combination, manipulation, indexing, and search.

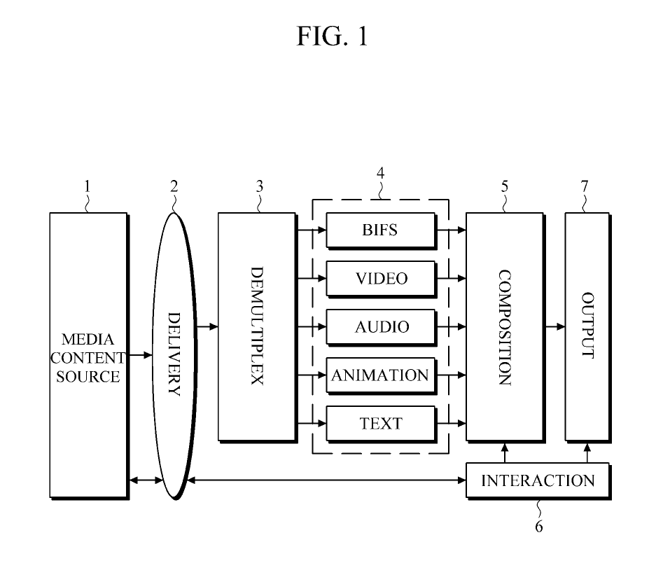

FIG. 1 is a diagram illustrating an MPEG-4 system reference model.

Referring to FIG. 1, after composing media objects that include interaction functions into a desired audio visual scene, the MPEG-4 system reference model multiplexes media data into bit streams and synchronizes the bit streams in an effort to ensure a quality of service (QoS), and transmits (2) a resulting media content source 1 to a receiver side. The receiver side demultiplexes (3) the received media content source 1 into various types of data, such as binary format for scene (BIFS), video, audio, animation, and text data, and the composition of the decoded data is performed (5) and the resulting data is output (7). In this case, the receiver side may have a system configuration capable of allowing an interaction (6) with the user to interact with the visual scene.

To overcome problems which may be caused by object overlapping in the MPEG-4 system reference model, grouping of independent visual objects is performed based on depth, scenes composed of visual objects of each grouping are produced, and the produced scenes are output to various screens through interaction with a user. For the convenience of explanation, MPEG-4 is taken as an example of the system reference model in FIG. 1. However, aspects of the invention are not limited thereto.

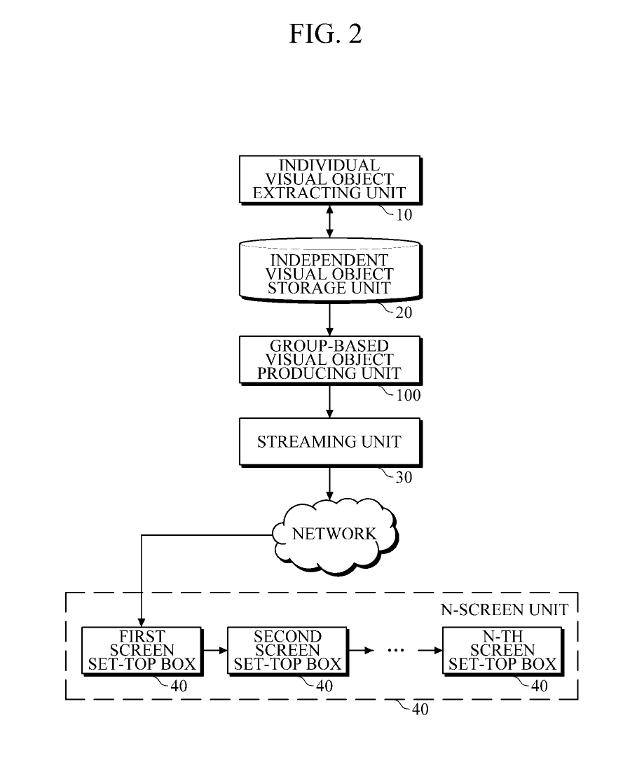

FIG. 2 is a configuration diagram illustrating an N-screen service providing apparatus using depth-based visual object groupings according to an exemplary embodiment of the present invention.

Referring to FIG. 2, the N-screen service providing apparatus includes an individual visual object extracting unit 10, a group-based visual object producing unit 100, and an N-screen unit 40. The N-screen service providing apparatus may further include an independent visual object storage unit 20 and a streaming unit 30.

The independent visual object extracting unit 10 extracts one or more independent visual objects from a video or a still image automatically or semi-automatically. For example, like Gaussian Model per pixel or a clustering model, background information corresponding to a background image is modeled, and a particular image input is compared with the background information to separate between background and foreground. More specifically, if a similarity between pixels of the input particular image is smaller than a reference similarity, then it is determined that the input image is different from a background model image, and an object extraction algorithm is applied to the pixels of the image which are assigned as foreground pixel candidates, so that an object corresponding to foreground can be extracted from the background.

In one aspect, the independent visual object extracting unit 10 assigns a depth value for each of the extracted independent visual objects. For example, object 1, which is located deepest, is assigned a depth value of “1”, and object 2 overlapping on object 1 is assigned a depth value of “2”.

The independent visual object storage unit 20 stores the one or more independent visual objects extracted by the independent visual object extracting unit 10. Here, independent visual object files that have been already stored may be re-edited by the independent visual object extracting unit 10.

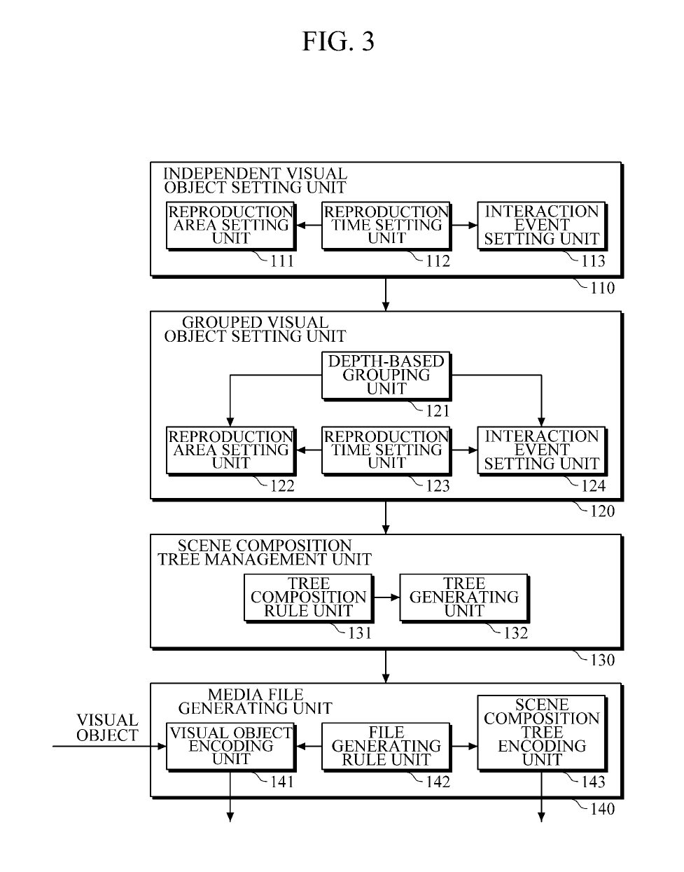

The group-based visual object producing unit 100 may divide the independent visual objects stored in the independent visual object storage unit 20 into groups based on depth, and produces visual object scenes composed of visual objects of each grouping. In specific, the one or more visual objects are divided into groups based on the depth values assigned by the independent visual object extracting unit 10, and scenes are produced according to spatial-temporal relationships and interaction events set for the visual objects of each group. This will be described in detail with reference to FIG. 3.

The streaming unit 30 streams the object groups, which are generated by the group-based visual object producing unit 100, to the N-screen unit 40 over a network. Although not illustrated, more specifically, the streaming unit 30 sets sessions through a session manager, sets a network channel using real-time streaming protocol (RTSP), generates packetized media streams that contain synchronous headers for efficient transmission and synchronous reception, using a network manager, and then transmit the media streams using real-time transport protocol (RTP) through an IP network.

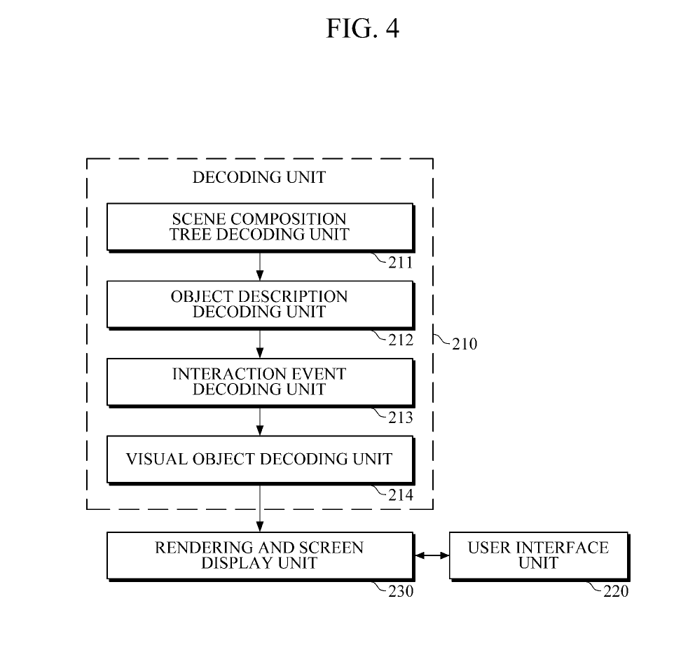

The N-screen unit 40 receives and decodes the streamed media objects to compose a scene, and reproduces the composed scene selectively on the N-screen according to a user interaction event. Here, the N-screen service refers to a next-generation computing/network service that enables the same content to be shared across diverse types of digital information devices with screens, including smartphones, personal computers, smart TVs, tablet PCs, and vehicles. Accordingly, a user can freely enjoy the same content on any digital devices regardless of time and place. For example, the user may download a movie to a computer and watch it on TV, then seamlessly watch the same content on a smartphone or a tablet PC on the subway. In the exemplary embodiments described herein, visual objects overlapping in a video or a still image are grouped together based on their depth values and scenes composed of visual objects of each grouping are displayed on different screens by use of an N-screen service, so that the hidden visual objects can be clearly displayed. Operation and configuration of the N-screen unit 40 will be described in detail with reference to FIG. 4.

FIG. 3 is a diagram illustrating in detail a group-based visual object producing unit according to an exemplary embodiment of the present invention.

Referring to FIG. 3, the group-based visual object producing unit 100 may include an independent visual object setting unit 110, a grouped visual object setting unit 120, a scene composition tree management unit 130, and a media file generating unit 140.

The independent visual object setting unit 110 may set spatial-temporal relationship information of at least one independent visual object and user interaction event information. Although not illustrated, there may be provided an interface to facilitate the user's setting of such information.

The independent visual object setting unit 110 may include a reproduction area setting unit 111, a reproduction time setting unit 112, and an interaction event setting unit 113.

The reproduction area setting unit 111 sets a spatial relationship between independent visual objects that compose a scene, as attributes of the independent visual object. The reproduction time setting unit 112 sets a reproduction start time and a reproduction end time, as the attributes of the individual visual object.

The interaction event setting unit 113 produces information regarding interaction event handling for a particular visual object. Interaction event handling is a process to define an event attribute field of each object with respect to user actions and associate objects with the actions in advance, such that the object can operate in response to the user action. For example, additional information is output in response to a mouse-clicking on a user player terminal, or an object at a desired location is displayed in response to a mouse dragging action. To set an interaction event, an event type, a target object of an action, a type of action, and a value to be changed according to a type of action are specified. Here, the event may include a user's object icon selection, user's clicking on the right mouse button, user's clicking on the left mouse button, user's mouse dragging, a user's menu selection, and a user's keyboard input. Further, the spatial-temporal information and the interaction event information, which are set as described above, are generated in a text object or a scene description.

The grouped visual object setting unit 120 may include a depth-based grouping unit 121, a reproduction area setting unit 122, a reproduction time setting unit 123, and an interaction event setting unit 124. According to an exemplary embodiment, a service provider produces groups of objects by grouping overlapping objects based on their depth values and sets spatial-temporal relationship information and user interaction event information of visual objects belonging to each group.

The depth-based grouping unit 121 divides a plurality of objects into one or more groups, based on depth values. For example, when assigned depth values from 1 to 4, visual objects with depth values of 2 and 3 may be grouped together into one group.

The reproduction area setting unit 122 sets a spatial relationship between objects belonging to each group that is generated by the depth-based grouping unit 121 wherein the objects compose a scene according to the spatial relationship. The reproduction time setting unit 123 sets reproduction start time and reproduction end time for objects of each grouping. The interaction event setting unit 124 produces event information of each grouped object, according to which a scene is changed in response to a user event, such as a mouse clicking event. The grouped visual object setting unit 120 repeatedly edits/produces the scene until the spatial-temporal relationships and interaction events for every grouped object are completely set.

By using the independent visual object setting unit 110 and the grouped visual object setting unit 120, event processing with respect to a user action is enabled in units of individual independent object, and event processing with respect to a user action is enabled in units of depth value-based object group.

The scene composition tree management unit 130 generates a scene composition tree by forming a database with a hierarchically structured tree of the generated attributes information, and changes the scene composition tree according to a change in an object produced by the user. The scene composition tree management unit 130 includes a tree composition rule unit 131 and a tree generating unit 132.

The media file generating unit 140 generates scene description and stream media including video and audio into media file by encoding in binary code and multiplexing. In this case, the scene description in binary code is referred to as a binary format for scene (BIFS).

FIG. 4 is a diagram illustrating an N-screen unit according to an exemplary embodiment of the present invention.

Referring to FIG. 4, when a user action is input, the N-screen unit 40 performs event processing on each object or each grouped object, as intended when edited/produced by the service provider. An event, as a device input, such as, a user's mouse or keyboard input, is processed, a user's menu selection, a mouse event, or a keyboard event is detected and interpreted, and then a module to process the event is invoked. For example, only some grouped objects among a number of overlapping objects may interact with the user. In addition, in a case where particular objects are intentionally hidden by the service provider, behind the overlapping objects, each of the hidden objects may be revealed when a user's particular action (e.g., mouse dragging or mouse clicking) is input, and the revealed objects may be processed to interact with the user's action. To this end, the N-screen unit includes a decoding unit 210, a user interface unit 220, and a rendering and screen display unit 230.

The decoding unit 210 decodes a streamed object file, that is, independent visual objects, grouped visual objects, object descriptions of each independent visual object and each grouped visual object, a scene description, and a scene composition tree.

The user interface unit 220 may be an input device, such as a mouse or a keyboard, to receive a user event, so as to perform the event processing on each object or each of object groups, as intended when edited/produced by a service provider. The rendering and screen display unit 230 interprets the user events including a user menu selection, a mouse event, and a keyboard event, which are input through the user interface unit 220, and display a scene decoded by the decoding unit 210. In one example, the rendering and screen display unit 230 selectively display one or more scenes with the groups of visual objects on one or more among at least two screens in response to a user interaction event.

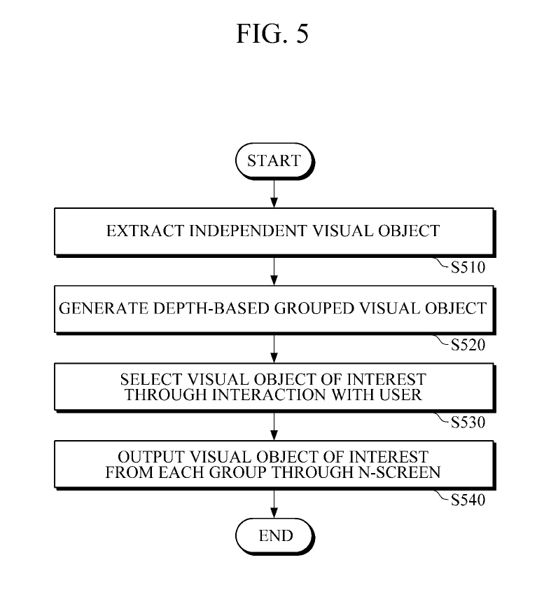

FIG. 5 is a flowchart illustrating a method of providing scenes composed of depth-based grouped visual objects through an N-screen service according to an exemplary embodiment of the present invention.

Referring to FIG. 5, in S510, one or more independent visual objects included in a video or still image are automatically or semi-automatically extracted. In this case, a depth value is assigned to each of the extracted independent visual objects. For example, object 1 that is located deepest is assigned a depth value of “1”, and object 2 overlapping object 1 is assigned a depth value of “2”.

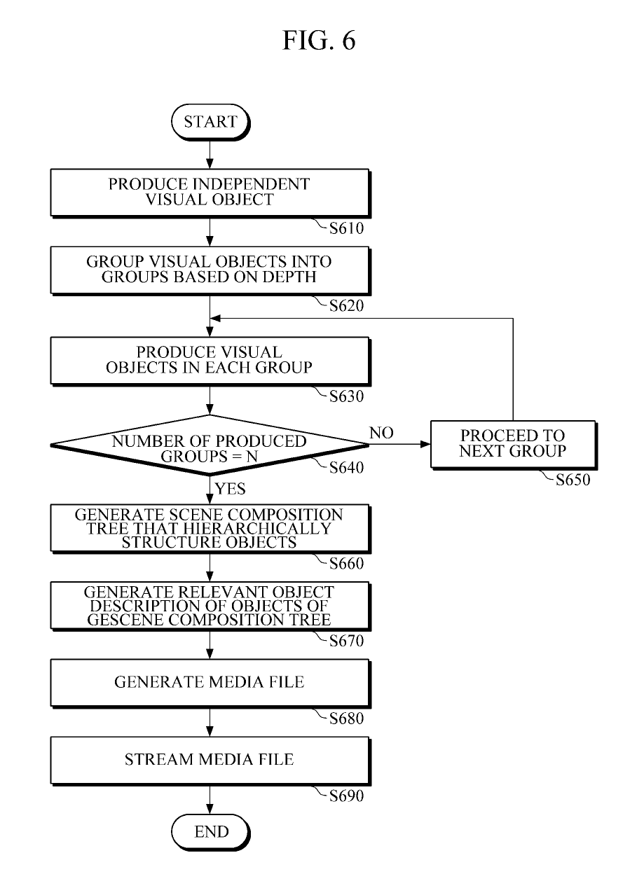

In S520, the extracted independent visual objects are divided into groups based on the depth values, and visual object scenes composed of visual objects of each grouping are produced. Specifically, one or more independent visual objects are divided into groups, and scenes are composed of visual objects of each grouping according to a spatial-temporal relationship between visual objects and an interaction event, which are set on a group-by-group basis. This process will be described in detail with reference to FIG. 6.

Although not illustrated in drawings, the produced groups of objects may be streamed to an N-screen over a network, and the N-screen decodes the received media objects, composes scenes from the decode media objects, and reproduces the scenes on N screens. Accordingly, visual objects overlapping in a video or a still image are grouped together based on their depth values and scenes composed of visual objects of each grouping are projected on different screens by use of an N-screen service, so that the hidden visual objects can be clearly displayed.

In S530, a visual object in interest is selected through an interaction with a user, and the visual object in interest is displayed on the N screens, on a group-by-group basis.

Operations S510 and S520 are described in detail with reference to FIG. 6.

FIG. 6 is a flowchart illustrating a process of producing a visual object group according to an exemplary embodiment of the present invention.

Referring to FIG. 6 and FIG. 2, in S610, the group-based visual object producing unit 100 sets spatial-temporal relationship information and user interaction event information of one or more independent visual objects. For the user convenience, an interface may be provided to facilitate the producing. More specifically, a spatial relationship between independent visual objects that compose a scene is set as attributes of the independent visual object. A reproduction start time and a reproduction end time are set as the attributes of the individual visual object. In addition, event information according to which a scene is changed in response to a user event, such as mouse clicking on a particular visual object, is produced.

In S620, the group-based visual object producing unit 100 divides the objects into groups based on depth value. For example, when assigned depth values from 1 to 4, only visual objects with depth values of 2 and 3 may be grouped together into one group.

In S 630, the group-based visual object producing unit 100 may set a spatial relationship between objects of each grouping, a reproduction start time and a reproduction end time for objects of each grouping, and event information according to which the scene is changed in response to a user event, such as mouse clicking, wherein the scene is composed of objects of each grouping. As a result, event processing with respect to a user action is enabled in units of independent object and also event processing with respect to a user action is enabled in units of depth value-based object group.

In S640, the group-based visual object producing unit 100 determines whether the number of produced visual object groups is N. In other words, the group-based visual object producing unit 100 determines whether all visual object groups are produced completely.

If a determination is made that N visual object groups are not completely produced in S640, the flow proceeds to S650.

If a determination is made that N visual object groups are completely produced in S640, the group-based visual object producing unit 100 generates a scene composition tree that hierarchically structures the objects in S660.

In addition, the group-based visual object producing unit 100 generates relevant object descriptions of objects inserted into the scene composition tree in S670. In specific, after event information is produced and an event object is generated, the event object may be added to a source object of an event. Scene information regarding the produced scene is obtained, and another scene that is generated based on the obtained scene information is generated as a scene description corresponding to the previously produced scene. In addition, an object descriptor which is information that contains an object identifier, a type of object, media encoding information and a size of object with respect to each media object including images, sound, and video which are included in a scene that is produced according to predetermined object descriptor generation rules is generated.

In S680, the group-based visual object producing unit 100 generates the scene description and stream media including video and audio into a media file by encoding in binary code and multiplexing. In S690, the group-based visual object producing unit 100 streams the generated medial file to the N-screen.

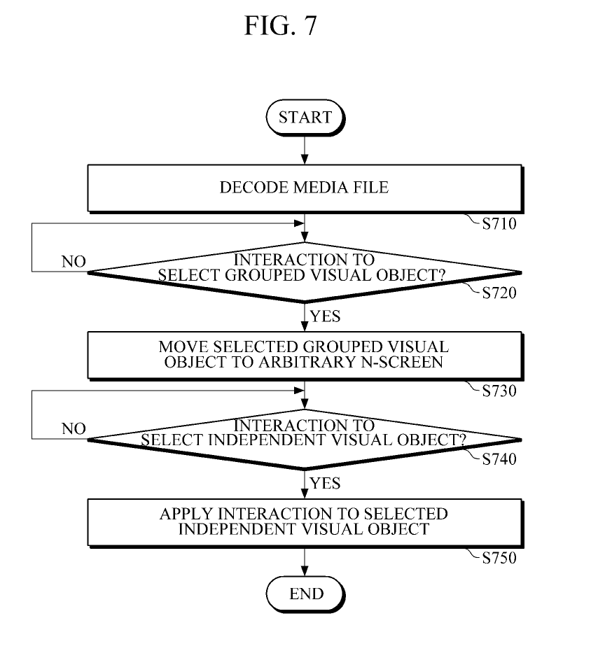

FIG. 7 is a flowchart illustrating a process of producing a visual object group according to an exemplary embodiment of the present invention.

Referring to FIG. 7 and FIG. 2, in S710, the N-screen unit 40 decodes a streamed media file. In this case, the N-screen unit 40 decodes the streamed media file into independent objects, object groups, a scene composition tree, and a description.

In S720, the N-screen unit 40 determines whether an interaction of a user with a visual object group is present.

If a determination is made that an interaction with a visual object group is present in S720, the N-screen unit 40 moves a selected visual object group to an arbitrary N-screen in S730.

In S740, the N-screen unit 40 determines whether an interaction to select an independent visual object is present. If it is determined that the interaction to select an independent visual object is present in S740, the N-screen unit 40 applies an interaction to the selected independent visual object. That is, in response to a user action, each object or an object group allows event processing to be performed as intended when edited/produced by the service provider.

Accordingly, only some grouped objects among a number of overlapping objects are enabled to interact with a user, and, in a case where particular objects are intentionally hidden by the service provider, behind the overlapping objects, each of the hidden objects may be edited to be revealed when a user's particular action (e.g., mouse dragging or mouse clicking) is input, and the revealed objects may be processed to interact with the user's action.

According to the exemplary embodiments of the present invention, in a case of a digital signage service that supports a multiple-screen service, such as a multi-vision service, a user can selectively extracts objects of interest from a scene being currently displayed on one screen, group together the extracted objects and additionally view the grouped objects on an individual screen, so that it is possible to improve targeted advertising effectiveness.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for providing an image service using at least two screens of different types in an N-screen service providing apparatus, the method comprising:
separating and extracting independent visual objects from an image;
grouping the extracted independent visual objects into a number of groups based on depth values and composing scenes with the respective groups of visual objects; and
selectively reproducing one or more scenes with the groups of visual objects on one or more among at least two screens in response to a user interaction event.

2. The method of claim 1, wherein the extracting of the independent visual objects comprises assigning a depth value to each of the independent visual objects.

3. The method of claim 1, wherein the producing of the scenes comprises grouping the independent visual objects into a number of groups that corresponds to a number of the screens.

4. The method of claim 1, further comprising:
streaming the scenes for the respective groups of visual objects to N-screens over a network.

5. The method of claim 1, wherein the producing of the scenes comprises:
setting spatial-temporal relationship information and user interaction event information of one or more independent visual objects;
grouping the one or more independent visual objects into groups based on depth values;
setting spatial-temporal relationship information and user interaction event information of visual objects belonging to each group;
generating a scene composition tree that hierarchically structures the information-set independent visual objects and the grouped visual objects; and
generating a media file by encoding the scene composition tree and the visual objects.

6. The method of claim 5, wherein the reproducing of the one or more scenes comprises determining whether a user interaction event with respect to a scene composed of grouped visual objects occurs, and moving a selected visual object to an arbitrary N-screen in response to a determination being made that the user interaction event with respect to the scene occurs.

7. The method of claim 1, wherein the reproducing of the one or more scenes comprises, in presence of a user's independent visual object selection interaction event, applying a user interaction event to a selected independent visual object.

8. An apparatus for providing an N-screen service using a depth-based visual object group, the apparatus comprising:
an independent visual object extracting unit configured to extract independent visual objects from an image;
a group-based visual object producing unit configured to group the extracted independent visual objects into a number of groups based on depth values and produce one or more scenes composed of visual objects of each grouping; and
an N-screen unit configured to comprise at least two screens to selectively reproduce the one or more produced scenes according to a user interaction event.

9. The apparatus of claim 8, wherein the independent visual object extracting unit assigns a depth value to each of the independent visual objects.

10. The apparatus of claim 8, wherein the group-based visual object producing unit groups the independent visual objects into a number of groups that corresponds to a number of the screens.

11. The apparatus of claim 8, further comprising:
a streaming unit configured to stream the scenes composed of each of the groups of visual objects to an N-screen over a network.

12. The apparatus of claim 11, wherein the streaming unit is configured to set network channel through session setting and real-time streaming protocol (RTSP), generate packetized media streams including synchronous headers, and transmit the media streams using a real-time transport protocol (RTP) through an IP network.

13. The apparatus of claim 8, wherein the group-based visual object producing unit is configured to comprise
an independent visual object setting unit configured to set spatial-temporal relationship information and user interaction event information of one or more independent visual objects;
a visual object group setting unit configured to group the one or more independent visual objects into groups based on depth values and set spatial-temporal relationship information and user interaction event information of visual objects belonging to each group;
a scene composition tree management unit configured to generate a scene composition tree that hierarchically structures the information-set independent visual objects and the grouped visual objects; and
a media file generating unit configured to generate a media file by encoding the scene composition tree and the visual objects.

14. The apparatus of claim 8, wherein the N-screen unit moves a selected visual object to an arbitrary N-screen in response to a determination being made that a user interaction event with respect to a scene composed of grouped visual objects.

15. The apparatus of claim 8, wherein when a user's independent visual object selection interaction event occurs, the N-screen unit applies a user interaction event to a selected independent visual object.
